(19) United States
(12) Patent Application Publication
(10) Pub. No.: US 2007/0292050 A1
(43) Pub. Date: Dec. 20, 2007

(54) Method and apparatus for rotating 2D image

(75) Inventor: Chih Peng Kuo, Hu Kou Hsiang (TW)

Correspondence Address: BIRCH STEWART KOLASCH & BIRCH, PO BOX 747, FALLS CHURCH, VA, 22040-0747, US

(73) Assignee: SONIX Technology Co., Ltd.

(21) Appl. No.: 11/700,881

(22) Filed: Feb. 1, 2007

(30) Foreign Application Priority Data
Jun. 16, 2006 (TW) 095121536

(51) Int. Cl. G06K 9/32; G09G 5/00

(52) U.S. Cl. 382/300; 345/660

(57) ABSTRACT

A two-dimensional image processing system and method is disclosed. The system receives an original image data and applies a rotating and/or scaling image processing to the original image data to generate a target image data.

### BACKGROUND OF THE INVENTION

1. Field of the Invention

The invention relates to an image processing system and the image processing method thereof, and more particularly, to a two-dimensional image processing system without buffers and the image processing method thereof.

2. Description of the Related Art

In regard to an image processing technology, it is usually the skills of rotating and scaling a two-dimensional image to be emphasized. It is also well known that, in a real-time image processing, the calculation for an image data to be rotated and/or scaled and the display of the processed image data are required to be synchronous. Conventionally, such an image processing system includes two ping-pong buffers acting as an interchange manner.

Referring to FIG. 1, the conventional two-dimensional image processing system 10 includes a memory unit 11, a two-dimensional image scaling-rotation device 12, and a display unit 13. The two-dimensional image scaling-rotation device 12 further includes a scaling-rotation unit 121, an output unit 122, a first buffer 123, and a second buffer 124. The scaling-rotation unit 121 of the two-dimensional image scaling-rotation device 12 receives an original image data Or stored in the memory unit 11 and then applies a rotating and/or scaling processing to the image data Or to generate a processed image data Af1.

Thereafter, the processed image data Af1 is stored temporarily in the first buffer 123 or the second buffer 124. Herein, the buffer 123 is presumed to be the one for the storage. At the same time, a previously processed image data Af0 which is temporarily stored in the second buffer 124 is read out by the output unit 122 and output to the display unit 13 for a display.

It is to be noted that once the output of the processed image data Af0 stored in the second buffer 124 is completed, the next processed image data Af2 from the scaling-rotation unit 121 will be temporarily stored in the buffer 124. Similarly, while the processed image data Af2 is stored, the previously processed image data Af1 stored in the buffer 123 is read out by the output unit 122 and output to the display unit 13.

In brief, the scaling-rotation unit 121 and the output unit 122 access the processed image data in the buffers 123 and 124 in an interchange manner so that any one of the buffer would not be accessed simultaneously by the scaling-rotation unit 121 and the output unit 122. That is why the buffers 123 and 124 are called as ping-pong buffers.

FIG. 2A schematically shows the above-mentioned original image data Or. The original image data Or is assumed to have 10×10 pixels with an included rectangular pattern A of which the four corner pixels are indicated by symbols O, P, Q, and R. Referring to FIG. 2B, an assumed processed image data Af_{N} (N is a positive number) also have the same 10×10 pixels but with an included rectangular pattern A′ that is the rotating and/or scaling result of the pattern A. The four corner pixels of the pattern A′ are indicated by symbols O′, P′, Q′, and R′.

Referring to FIG. 2C, the coordinate diagram is shown with regard to the original image data Or including the pattern A in FIG. 2A and the processed image data Af_{N} including the pattern A′ in FIG. 2B. In FIG. 2C, the coordinate (x1, y1) of the pixel O is taken as the starting point of rotation, the coordinate (x2, y2) of the pixel O′ is taken as the end point of rotation, and the coordinate (x0, y0) of the pixel G is taken as the center of rotation, wherein the rotation angle is θ.

According to mathematics, the coordinate of every pixel on the rectangular pattern A′ which is the rotating and/or scaling result through the two-dimensional image scaling-rotation device 12 such as the coordinate (x2, y2) of the pixel O′ can be calculated out from equation (1).

$$[ \begin{matrix}x 2 \\ y 2\end{matrix} ] = [ \begin{matrix}{A}^{′} & {B}^{′} \\ {C}^{′} & {D}^{′}\end{matrix} ] [ \begin{matrix}x 1 - x 0 \\ y 1 - y 0\end{matrix} ] + [ \begin{matrix}x 0 \\ y 0\end{matrix} ] \qquad ( 1 )$$

In equation (1), (x0, y0) represents the center of rotation (such as the coordinate of point G), (x1, y1) represents the coordinate of pixels before the rotating and/or scaling processing (such as the coordinate of pixel O), (x2, y2) represents the coordinate of pixels after the rotating and/or scaling processing (such as the coordinate of pixel O′). The

$$[ \begin{matrix}{A}^{′} & {B}^{′} \\ {C}^{′} & {D}^{′}\end{matrix} ]$$

is a matrix of rotation and the coefficients A′, B′, C′, and D′ in the matrix of rotation can be obtained through the equations (2) to (5). In these equations, θ represents the above-mentioned angle of rotation, α represents the scaling parameter in X-axis direction, and β represents the scaling parameter in Y-axis direction with α and β having positive values. Thus, it is θ to determine the rotation of the rectangular pattern A, and it is α and β to determine the size of the rectangular pattern A.

$$\begin{matrix}{A}^{′} = \frac{1}{α} cos ú c & ( 2 ) \\ {B}^{′} = \frac{1}{α} sin ú c & ( 3 ) \\ {C}^{′} = \frac{1}{β} sin ú c & ( 4 ) \\ {D}^{′} = \frac{1}{β} cos ú c & ( 5 )\end{matrix}$$

As shown in FIGS. 2B and 2C, the rectangular pattern A is compressed and extended to be the rectangular pattern A′ and the image data Af_{N} is therefore generated with the calculations of the equations (1) to (5). In other words, the two-dimensional image scaling-rotation device 12 calculates the coordinates of every pixel that is originally on the original image data Or but rotated and/or scaled during an image processing according to the equations (1) to (5), and stores the coordinates in the buffer 123 or 124. Then, the output unit 122 and the display unit 13 access the coordinates to display the rotated and/or scaled image.

However, before a calculating operation of the equations (1) to (5), there is generally a need for the image processing system 10 to grating scan the original image data Or in a left-to-right and up-to-down manner, which disables the image processing system 10 from displaying the processed image in real-time. For example, referring to FIGS. 2A and 2B, when the image processing system 10 completes scanning the pixel P, the coordinate of pixel P′ on the image data Af_{N} is calculated out and temporarily stored in the buffer 123 or 124 and the pixel P is simultaneously output at the coordinate of pixel P′. At this time, since the coordinates of other pixels on the original image data are not obtained yet, the image data Af_{N} stored in the buffer 123 or 124 is not completed and the display of the image including only pixel P will occur error.

In other words, in the image processing system 10, the display unit 13 can not directly display a whole image including the pixels that are rotated and/or scaled in real time until all the pixels on the original image data Or are scanned and processed, and the image data Af_{N} stored in the buffer 123 or 124 is completed.

Besides, the capacity of the buffer 123 or 124 is required to at least capable of storing the original image data Or or the processed image data Af_{N}. In this case, during the rotating and/or scaling processing of the original image data Or, the larger the original image data Or or the processed image data Af_{N} is, the larger the capacity of the buffer is needed, and which make the cost raise.

Therefore, it is the target to perform a two-dimensional image processing including rotating and scaling, and display the processed image in real time without raising the cost on the buffers or even without using the buffers.

### BRIEF SUMMARY OF THE INVENTION

In view of the above-mentioned problems, an objective of the present invention is to provide a two-dimensional image processing method and system enable to apply rotating and/or scaling processing to an image without using the buffers, and to display the image in real time.

To achieve the objective, one embodiment of this invention provides a two-dimensional image processing system. The system receives an original image data and applies a rotating and/or scaling image processing to the original image data to generate a target image data. The two-dimensional image processing system includes a scaling-rotation unit and an output unit. The scaling-rotation unit calculates out a plurality of original coordinates corresponding to a plurality of coordinates of a processed image from knowing the coordinate of a center of rotation, an angle of rotation, and two scaling parameters, and reads out the pixels of the original image data according to the original coordinates. Further, the processed coordinates indicate the coordinates of the pixels inside or outside the target image data, and the original coordinates indicate the coordinates of the pixels inside or outside the original image data.

The output unit receives the pixels and outputs the pixels at the processed coordinates one-by-one to generate the target image data.

On the other hand, another embodiment of this invention also provides a two-dimensional image processing method for making an original image data to be rotated and/or scaled to generate a target image data. The method includes the following steps:

Calculating out a plurality of original coordinates corresponding to a plurality of processed coordinates according to the coordinate of a center of rotation, an angle of rotation, and two scaling parameters; reading out the pixels of the original image data according to the original coordinates. Similarly, the processed coordinates indicate the coordinates of the pixels inside or outside the target image data, and the original coordinates indicate the coordinates of the pixels inside or outside the original image data. In addition, the method includes an outputting step to receive the pixels and output the pixels at the processed coordinates one-by-one to generate the target image data.

It will be seen that according to the two-dimensional image processing system and method of embodiments of the invention, the processed coordinates of every pixel are taken as references to calculate back the corresponding original coordinate on the original image data, and then fills the processed coordinates with the pixels on the corresponding original coordinates. The way of processing an image is quite different from one-by-one processing every pixel on the original image data, and every processed pixel can be directly output without being temporarily stored in buffers.

Therefore, the two-dimensional image processing system and method of embodiments of the invention can directly catch and display the pixel on the target image data without using any buffer, and solves the problems of high cost of using buffers in the conventional art, and achieves a goal of displaying the image data in real time.

### BRIEF DESCRIPTION OF THE DRAWINGS

FIG. 1 shows a schematic diagram illustrating a conventional two-dimensional image processing system.

FIG. 2A shows a schematic diagram illustrating an original image data.

FIG. 2B shows a schematic diagram illustrating a processed image data.

FIG. 2C shows the coordinate diagram with regard to the original image data shown in FIG. 2A and the processed image data shown in FIG. 2B.

FIG. 3 shows a schematic diagram illustrating a two-dimensional image processing system according to one embodiment of this invention.

FIG. 4A shows a schematic diagram illustrating an original image data.

FIG. 4B shows a schematic diagram illustrating a target image data.

FIG. 5 shows a flow chart illustrating a two-dimensional image processing method according to the present invention.

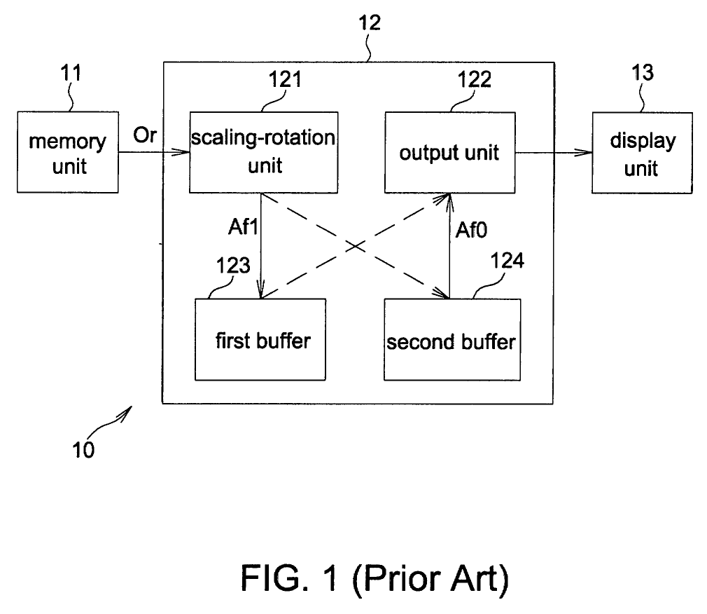

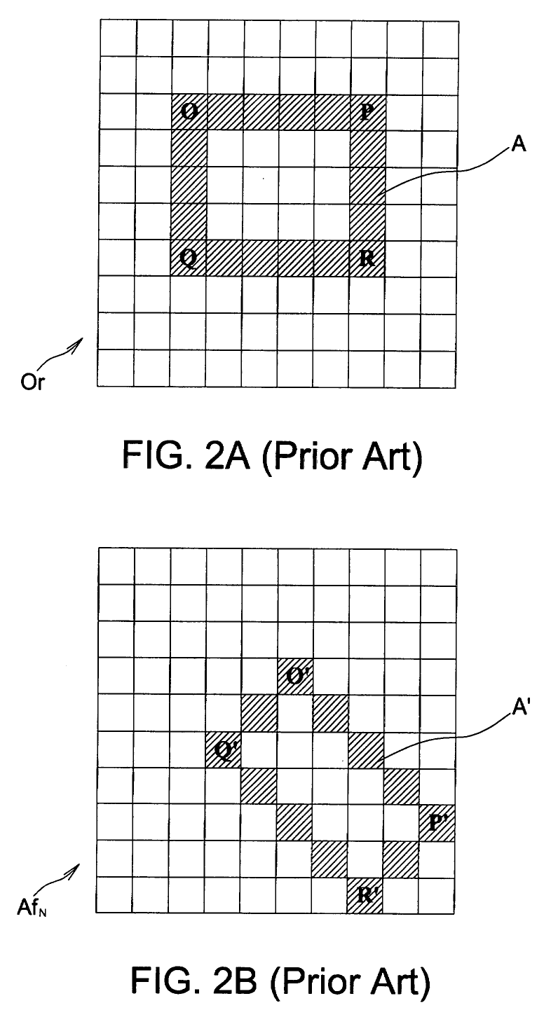

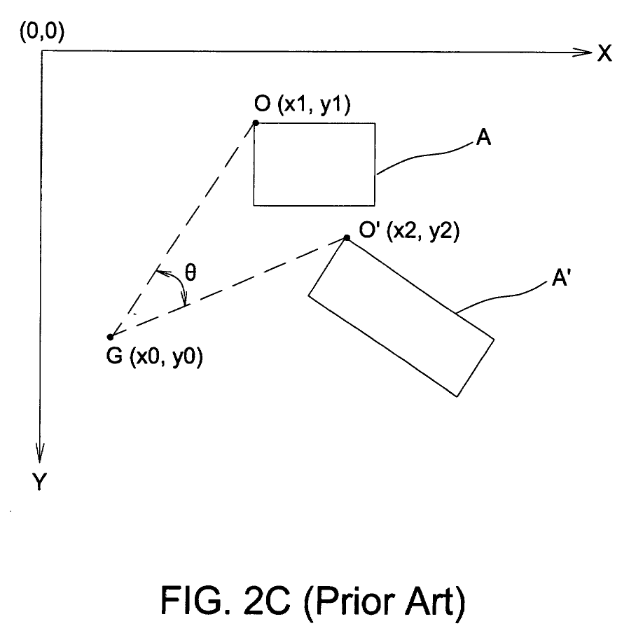

### DETAILED DESCRIPTION OF THE INVENTION

Reference will now be made to the drawings in which the various elements of the present invention will be given numerical designations and in which the invention will be discussed so as to enable one skilled in the art to make and use the invention.

The embodiments of the invention will be described herein below with reference to the accompanying drawings.

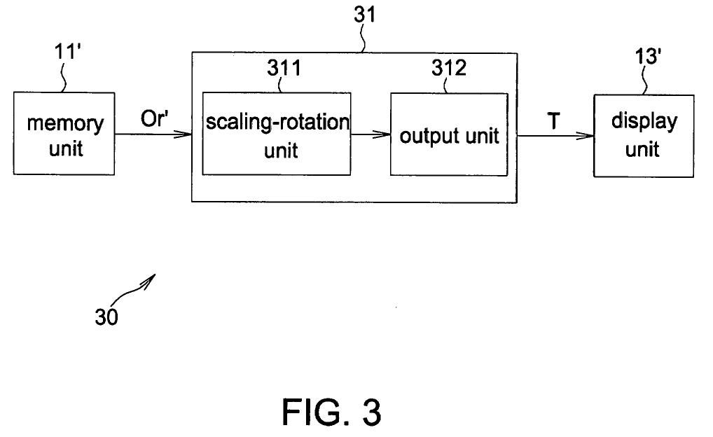

Referring to FIG. 3, a two-dimensional image processing system 30 according to one embodiment of the invention includes a memory unit 11′, a two-dimensional image scaling-rotation device 31, and a display unit 13′. The two-dimensional image scaling-rotation device 31 further includes a scaling-rotation unit 311 and an output unit 312. The two-dimensional image scaling-rotation device 31 receives the original image data Or′ stored in the memory unit 11′ and applies a rotating and/or scaling image processing to the original image data Or′ to generate a target image data T, and then displays the target image data T via the display unit 13′.

The scaling-rotation unit 311 calculates out a plurality of original coordinates (x1, y1) corresponding to a plurality of coordinates (x2, y2) of a processed image from knowing the coordinate of a center of rotation (x0, y0), an angle of rotation θ, and two scaling parameters αand β. Then, the pixels on the original image data Or′ are read out according to the original coordinates (x1, y1) and then output. Herein, the coordinates (x2, y2) indicate the coordinates of the pixels inside or outside the target image data, i.e., the coordinates that with or without pixels on the target image data, while the original coordinates (x1, y1) indicate the coordinates of the pixels inside or outside the original image data Or′.

The output unit 312 receives one-by-one the pixels on the original image data Or′, and outputs one-by-one these pixels at the corresponding processed coordinates (x2, y2) and then generates the target image data T.

While the two-dimensional image processing system 30 operates, the scaling-rotation unit 311 calculates out the original coordinates (x1, y1) from the equation (6).

$$[ \begin{matrix}x 1 \\ y 1\end{matrix} ] = [ \begin{matrix}A & B \\ C & D\end{matrix} ] [ \begin{matrix}x 2 - x 0 \\ y 2 - y 0\end{matrix} ] + [ \begin{matrix}x 0 \\ y 0\end{matrix} ] \qquad ( 6 )$$

In equation (6), (x0, y0) represents the center of rotation, (x1, y1) represents the original coordinates, and (x2, y2) represents the processed coordinates, and

$$[ \begin{matrix}A & B \\ C & D\end{matrix} ]$$

is a reverse matrix of rotation. The coefficients A, B, C and D in the reverse matrix of rotation

$$[ \begin{matrix}A & B \\ C & D\end{matrix} ]$$

can be obtained from the equations (7) to (10).

$$\begin{matrix}A = \frac{1}{α} cos ( 360 ° - ú c ) & ( 7 ) \\ B = \frac{1}{α} sin ( 360 ° - ú c ) & ( 8 ) \\ C = - \frac{1}{β} sin ( 360 ° - ú c ) & ( 9 ) \\ D = \frac{1}{β} cos ( 360 ° - ú c ) & ( 10 )\end{matrix}$$

In these equations, θ represents the angle of rotation from 0 to 360 degrees (including 0 and 360 degrees), and α represents a scaling parameter in the X-axis direction while β represents another scaling parameter in the Y-axis direction, and both α and β have positive values. At first, the scaling-rotation unit 311 obtains the reverse matrix of rotation

$$[ \begin{matrix}A & B \\ C & D\end{matrix} ]$$

according to the equations (7), (8), (9) and (10) with the pre-defined angle of rotation θ and the scaling parameters α and β. Then, the scaling-rotation unit 311 obtains the original coordinates (x1, y1) of the whole original image data Or′ including the boundaries thereof according to the equation (6) with the reverse matrix of rotation

$$[ \begin{matrix}A & B \\ C & D\end{matrix} ] ,$$

the coordinate of center of rotation (x0, y0), and the processed coordinates (x2, y2).

It is to be noted that the scaling-rotation unit 311 also checks that whether the obtained corresponding original coordinates (x1, y1) have pixels of the original image data Or′. If there is no pixel of the original image data Or′ on the obtained original coordinates (x1, y1), then the processed coordinate (x2, y2) will be filled with a specific pixel such as a specific color like water-blue and water-green, or a transparent code pixel. Besides, the coordinate of center of rotation (x0, y0) can be located inside or outside the original image data Or′ or on the boundary of the original image data Or′.

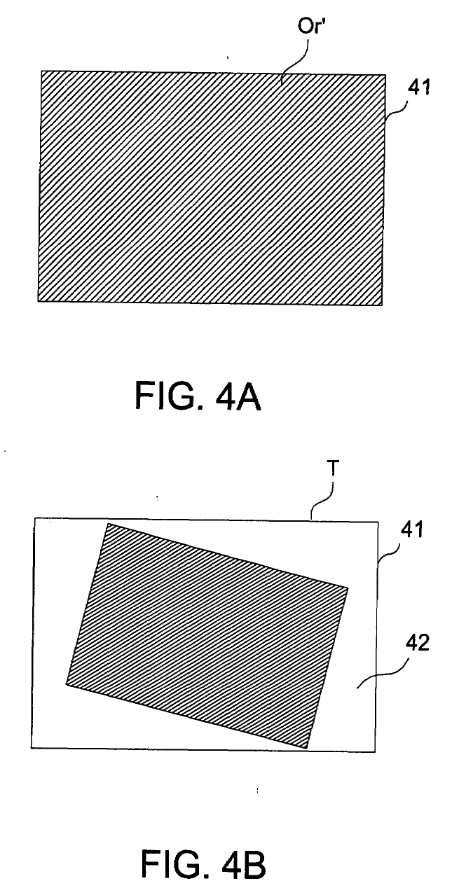

Referring to FIGS. 3, 4A, and 4B, the original image data Or′ and the target image data T are image data of 512×256 pixels. Examples are now illustrated to show how the two-dimensional image scaling-rotation device 31 is used to change the original image data Or′ stored in the memory unit 11′ into the target image data T for the display unit 13′. The parameters needed in the equations (6), (7), (8), (9) and (10) are substituted by the following values: (x2, y2)=(0, 0)˜(511, 255), (x0, y0)=(256, 128), θ=10°, α=1.1, β=1.33.

We substitute the θ, α, β, in the equations (7), (8), (9), and (10) with 10, 1.1, 1.33 respectively, and then we obtain the reverse matrix of rotation

$$[ \begin{matrix}A & B \\ C & D\end{matrix} ]$$

as follows:

$$[ \begin{matrix}A & B \\ C & D\end{matrix} ] = [ \begin{matrix}\frac{1}{α} cos ( 360 ° - θ ) & \frac{1}{α} sin ( 360 ° - θ ) \\ - \frac{1}{β} sin ( 360 ° - θ ) & \frac{1}{β} cos ( 360 ° - θ )\end{matrix} ] = [ \begin{matrix}0.8952 & - 0.1578 \\ 0.1305 & 0.7404\end{matrix} ] .$$

All of the corresponding original coordinates (x1, y1) can be obtained by substituting (x0, y0) and (x2, y2) in equation (6) with (256, 128) and (0, 0)˜(511, 255), respectively. For example, (x1, y1) is (47, 0) when the processed coordinate (x2, y2) is (0, 0). The scaling-rotation unit 311 reads out the pixel on the coordinate (47, 0) of the original image data Or′ to the processed coordinate (0, 0) on the target image data T, and then the output unit 312 outputs the pixel at the processed coordinate (0, 0) on the target image data T.

Similarly, we substitute (x0, y0) and (x2, y2) in equation (6) with (256, 128) and (119, 67) respectively and obtain that the corresponding original coordinate (x1, y1) is (143, 65). The scaling-rotation unit 311 reads out the pixel on the coordinate (143, 65) of the original image data Or′ to the processed coordinate (119, 67) on the target image data T, and then the output unit 312 outputs the pixel at the processed coordinate (119, 67) on the target image data T.

The scaling-rotation unit 311 takes the processed coordinates (x2, y2) of every pixel as a reference to calculate back the corresponding original coordinate (x1, y1) on the original image data Or′, and then fills the processed coordinates (x2, y2) with the pixels on the corresponding original coordinates (x1, y1). The way of processing an image is quite different from one-by-one processing every pixel on the original image data Or′, and every processed pixel can be directly output without being temporarily stored in buffers.

In brief, the two-dimensional image processing system 30 of the invention uses the scaling-rotation unit 311 of the two-dimensional image scaling-rotation device 31 to scan the processed coordinates (x2, y2) (ranges from (0, 0) to (511, 255)), and calculates out the corresponding original coordinates (x1, y1) according to the equations (6), (7), (8), (9) and (10). And then the pixels on the original coordinates (x1, y1) are caught directly to complete the whole image rotation and scale in real time. Of course, the scaling-rotation unit 311 can perform the scan in turns or with a time interval or in any other designed manners. Therefore, the two-dimensional image processing system 30 of the invention can directly catch and display the pixel on the target image data T without using any buffer, and solves the problems of high cost of using buffers in the conventional art, and achieves a goal of displaying the image data in real time.

Furthermore, referring to FIGS. 4A and 4B, the whole display area 41 is filled with the pixels on the original image data Or′ which is not been rotated and/or scaled, while the whole display area 41 is partly filled with the pixels on the target image data T. In other words, the target image data T generated from rotating and scaling the original image data Or′ by the two-dimensional image processing system 30 is possibly not able to fill the whole display area 41 due to the change of position and size, and part of the display area 41 of the target image data T may become blank area 42. Therefore, when the scaling-rotation unit 311 checks that the obtained corresponding original coordinates (x1, y1) from each of the processed coordinates (x2, y2) do not have pixels of the original image data Or′, the scaling-rotation unit 311 considers that the referenced processed coordinates (x2, y2) must in the blank area 42, and fills the processed coordinates (x2, y2) with a specific pixel such as a specific color like water-blue and water-green, or a transparent code pixel.

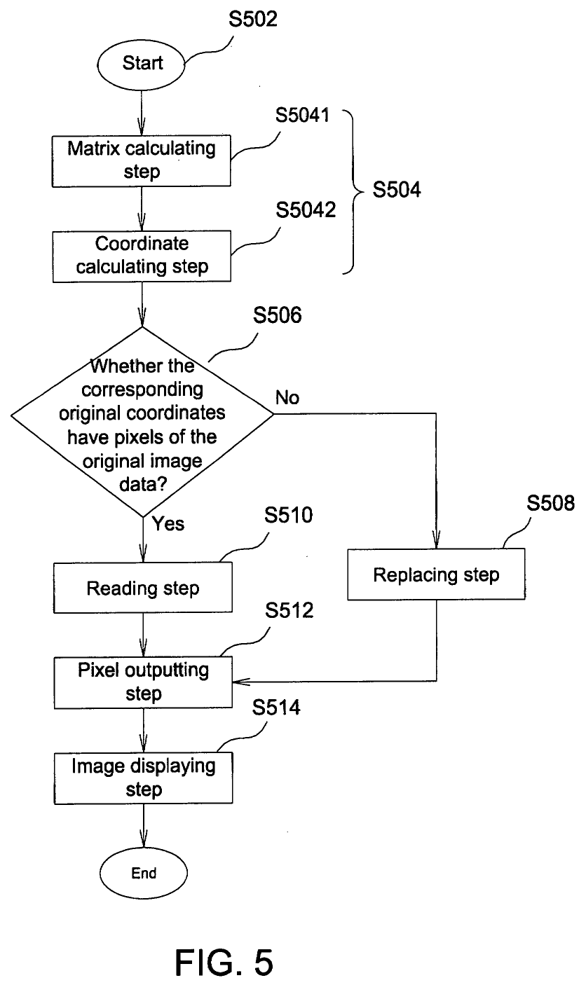

Referring to FIG. 5, a two-dimensional image processing method is shown. The method describes steps of rotating and/or scaling an original image data to generate a target image data and these steps are as follows:

Step S502: Start.

Step S504: Calculate out the original coordinates corresponding to the processed coordinates according to the coordinate of center of rotation, the angle of rotation, and two scaling parameters, wherein the processed coordinates are those of pixels inside or outside the target image data and the original coordinates are those of pixels inside or outside the original image data.

In the following, the step 504 is further explained with the sub-steps S5041 (matrix calculating step) and S5042 (coordinate calculating step).

Step S5041: Calculate out a reverse matrix of rotation according to the above-mentioned equations (7), (8), (9), and (10) with the angle of rotation and the scaling parameters.

Step S5042: Calculate out the original coordinate according to the above-mentioned equation (6) with the reverse matrix of rotation, the center of rotation, and the processed coordinate.

Step S506: Determine whether the corresponding original coordinates obtained from each of the processed coordinates have pixels of the original image data. If yes, go to step S510 and S512 respectively; if no, go to step S508 and S512, respectively.

Step S508: Fill the processed coordinate with a specific pixel such as a specific color or a transparent code pixel.

Step S510: Read out the pixels of the original image data one-by-one according to the original coordinates.

Step S512: Output the pixels at the processed coordinates and then generate a target image data.

Step S514: Receive the pixels at the processed coordinates and display the target image data.

Step S516: End.

In the above-mentioned two-dimensional image processing method, the coordinate of center of rotation can be located inside or outside the original image data or the boundary of the original image data. The original image data is stored in a memory unit, and the target image data is output to be displayed via a display unit.

While the invention has been described by way of examples and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A two-dimensional image processing system to receive an original image data and apply a rotating and/or scaling image processing to the original image data to generate a target image data, the system comprising:
a scaling-rotation unit which calculates out a plurality of original coordinates corresponding to a plurality of processed coordinates according to the coordinate of a center of rotation, an angle of rotation, and two scaling parameters, and reads out the pixels of the original image data according to the original coordinates, wherein the processed coordinates indicate the coordinates of the pixels inside or outside the target image data, and the original coordinates indicate the coordinates of the pixels inside or outside the original image data; and
an output unit which receives the pixels and outputs the pixels at the processed coordinates to generate the target image data.

2. The two-dimensional image processing system as set forth in claim 1, further comprising a display unit which receives the pixels at the processed coordinates and displays the target image data.

3. The two-dimensional image processing system as set forth in claim 1, wherein the scaling-rotation unit calculates out a reverse matrix of rotation according to the angle of rotation and the scaling parameters and calculates out the original coordinates according to the reverse matrix of rotation, the coordinate of center of rotation, and the processed coordinates.

4. The two-dimensional image processing system as set forth in claim 3, wherein the reverse matrix of rotation is
$$[ \begin{matrix}A & B \\ C & D\end{matrix} ] ,$$
and the coefficients A, B, C, and D are calculated out from the following equations:
$$\begin{matrix}A = \frac{1}{α} cos ( 360 ° - ú c ) \\ B = \frac{1}{α} sin ( 360 ° - ú c ) \\ C = - \frac{1}{β} sin ( 360 ° - ú c ) \\ D = \frac{1}{β} cos ( 360 ° - ú c )\end{matrix}$$
wherein θ represents the angle of rotation, α represents the scaling parameter in the X-axis direction, and β represents the scaling parameters in the Y-axis direction with α and β having positive values; and
wherein the original coordinates are calculated out from the following equations:
$$[ \begin{matrix}x 1 \\ y 1\end{matrix} ] = [ \begin{matrix}A & B \\ C & D\end{matrix} ] [ \begin{matrix}x 2 - x 0 \\ y 2 - y 0\end{matrix} ] + [ \begin{matrix}x 0 \\ y 0\end{matrix} ]$$
wherein (x0, y0) represents the coordinate of center of rotation, (x1, y1) represents the original coordinates, (x2, y2) represents the processed coordinates, and
$$[ \begin{matrix}A & B \\ C & D\end{matrix} ]$$
represents the reverse matrix of rotation.

5. The two-dimensional image processing system as set forth in claim 1, wherein the scaling-rotation unit judges whether the corresponding original coordinates obtained are included in the original image data, if no then a specific pixel is output on the processed coordinates.

6. A two-dimensional image processing method for making an original image data to be rotated and/or scaled to generate a target image data, the system comprising:
calculating out a plurality of original coordinates corresponding to a plurality of processed coordinates according to the coordinate of a center of rotation, an angle of rotation, and two scaling parameters, and reading out the pixels of the original image data according to the original coordinates, wherein the processed coordinates indicate the coordinates of the pixels inside or outside the target image data, and the original coordinates indicate the coordinates of the pixels inside or outside the original image data; and
outputting the pixels at the processed coordinates to generate the target image data.

7. The two-dimensional image processing method as set forth in claim 6, further comprising a displaying step in which the pixels at the processed coordinates are received and the target image data is displayed.

8. The two-dimensional image method as set forth in claim 6, wherein the original coordinates are obtained through the following steps:
calculating out a reverse matrix of rotation according to the angle of rotation and the scaling parameters; and
calculating out the original coordinates according to the reverse matrix of rotation, the coordinate of center of rotation, and the processed coordinates.

9. The two-dimensional image processing method as set forth in claim 8, wherein the reverse matrix of rotation is
$$[ \begin{matrix}A & B \\ C & D\end{matrix} ] ,$$
and the coefficients A, B, C, and D are obtained from the following equations:
$$\begin{matrix}A = \frac{1}{α} cos ( 360 ° - ú c ) \\ B = \frac{1}{α} sin ( 360 ° - ú c ) \\ C = - \frac{1}{β} sin ( 360 ° - ú c ) \\ D = \frac{1}{β} cos ( 360 ° - ú c )\end{matrix}$$
wherein θ represents the angle of rotation, α represents the scaling parameter in the X-axis direction, and β represents the scaling parameters in the Y-axis direction with α and β having positive values; and
wherein the original coordinates are obtained from the following equations:
$$[ \begin{matrix}x 1 \\ y 1\end{matrix} ] = [ \begin{matrix}A & B \\ C & D\end{matrix} ] [ \begin{matrix}x 2 - x 0 \\ y 2 - y 0\end{matrix} ] + [ \begin{matrix}x 0 \\ y 0\end{matrix} ]$$
wherein (x0, y0) represents the coordinate of center of rotation, (x1, y1) represents the original coordinates, (x2, y2) represents the processed coordinates, and
$$[ \begin{matrix}A & B \\ C & D\end{matrix} ]$$
represents the reverse matrix of rotation.

10. The two-dimensional image processing method as set forth in claim 6, further comprising:
an judging step to see whether the corresponding original coordinates obtained have pixels of the original image data, if not then a specific pixel is output at the processed coordinates.
